(19) United States
(12) Patent Application Publication
(10) Pub. No.: US 2007/0164540 A1
(43) Pub. Date: Jul. 19, 2007

(54) Container

(76) Inventor: Ron Van Dijk, Melsele (BE)

Correspondence Address: SUGHRUE MION, PLLC, 2100 PENNSYLVANIA AVENUE, N.W., SUITE 800, WASHINGTON, DC, 20037, US

(21) Appl. No.: 10/549,747

(22) PCT Filed: Aug. 25, 2003
(86) PCT No.: PCT/BE03/00142

§ 371 Date: Sep. 5, 2006

(30) Foreign Application Priority Data
Mar. 21, 2003 (EP) 0307583.61

(51) Int. Cl. B62B 1/00

(52) U.S. Cl. 280/651

(57) ABSTRACT

A container, in particular a container provided for transporting goods, said container being formed by at least two elements (20-1), (20-2) each comprising a base part and side walls, said base parts being formed by a set-up of fingers (21,22) and grooves (23,24) mounted in such a manner that the fingers (21,22) of one base part engage into the grooves (23,24) of another base part, thereby enabling a telescopic engagement of the base parts in order to adapt the container's width, whereby the fingers (21,22) of one of the base parts have at their edges, facing their respective groove, each time an essentially C-shaped profile (27) in which is housed a wheel (28), said wheel (28) being mounted on an axle (31) fixed on a finger of another base part, and wherein each base part is provided with a cover plate (2) extending within a volume delimited by said side walls, one of said cover plates (2) forming a top cover plate and the other cover plates being mounted in such a manner that they shift underneath said top cover plate during said telescopic engagement.

The present invention relates to a container, in particular a container provided for transporting goods, said container being formed by at least two elements each comprising a base part and side walls, said base parts being formed by a set-up of fingers and grooves mounted in such a manner that the fingers of one base part engage into the grooves of another base part thereby enabling a telescopic engagement of the base parts in order to adapt the container's width.

Such a container is known from U.S. Pat. No. 5,007,550. The known container is used for transporting goods by loading the container with the goods to be shipped on a truck or on a cargo ship. Due to the fact that at least two elements telescopically engage into each other, the width of the container can be adapted to goods of a different size. For enabling this telescopic engagement, the base parts and the perpendicular walls are formed by grooves and fingers.

A drawback of the known container is that the base parts as well as the perpendicular parts are provided with such a finger and groove set-up. This is required to obtain a mutual locking of the assemblies of the fingers in the grooves and vice versa. Such a constructions is however cumbersome and expensive.

It is an object of the present invention to provide a container having a simpler construction without affecting the functioning of the telescopic engagement.

For this purpose, a container according to the present invention is characterised in that the fingers of one of the base parts have at their edges, facing their respective groove, each time an essentially C-shaped profile in which is housed a wheel, said wheel being mounted on an axle fixed on a finger of another base part, and wherein each base part is provided with a cover plate extending within a volume delimited by said side walls, one of said cover plates forming a top cover plate and the other cover plates being mounted in such a manner that they shift underneath said top cover plate during said telescopic engagement. Due to the fact that the C-shaped profile, facing the groove, houses a wheel which is mounted on an axle fixed on a finger of the other base part, it is the co-operation of the wheel and the C-shaped profile which guides the telescopic movement. Because the C-shaped profiles are part of the fingers of the one base part and the wheels are part of the fingers of the other base part, a co-operation between the fingers of the different base parts is thus obtained when they telescopically engage into each other, thereby obtaining a suitable and well guided engagement of the base parts without requiring the presence of grooves and fingers in the walls. Moreover, the presence of cover plates and the fact that they shift underneath the top cover plate enables to obtain a substantially flat floor inside the container.

A first preferred embodiment of a container according to the invention is characterised in that said container further comprises a front and a back wall extending substantially perpendicular to a direction in which said telescopic engagement extends, one of said front or back walls being provided with a door fixed to said container by means of hinges, said door being applied in such a manner as to pivot towards at least one open position where an under edge of said door substantially contacts one of said cover plates and forms a ramp towards said volume of said container. In such a manner the door not only serves to close the container but also as an access ramp. Because the under edge contacts the cover plates, no obstacle is formed upon loading the goods into the container.

A second preferred embodiment of a container according to the invention is characterised in that said container is provided with locking means provided to lock said elements in a plurality of positions each corresponding to a stage within said telescopic engagement. In such a manner, the container can be locked at different widths.

A third preferred embodiment of a container according to the invention is characterised in that said fingers are formed by two plate segments extending substantially parallel with respect to each other and connected together by means of intermediate elements in such a manner that the two plate segments are at a predetermined distance from each other, and wherein the intermediate elements applied in said one base part form said C-shaped profile and the intermediate elements of said another base part are provided to carry said axle. In such a manner the C-shaped profile is formed by the construction of the finger itself.

A fourth preferred embodiment of a container according to the invention is characterised in that said door is formed by a metal sheet, in particular aluminum, and provided with side edges obtained by folding said metal sheet twice over an angle of substantially 90° in order to form an elongated cavity, said hinges having a first hinge part lodged into said elongated cavity. The double folding in the metal sheet not only rigidifies the door construction but furthermore offers a housing for the first hinge part, thereby protecting the latter.

A fifth preferred embodiment of a container according to the invention is characterised in that said hinges have a second hinge part, said first and second hinge parts being each time formed by a little bar and connected together by an axle so as to enable a hinge movement, said second hinge part being applied against said side wall. The little bar shape of the hinge enables a flat construction of the hinge thereby minimising the space taken by the hinge. In such a manner, the hinge does not form an obstacle for the goods to be loaded into the container.

Preferably said hinges have a third and a fourth part, said third part being applied under a dome obtained by folding said metal sheet along an axis substantially parallel with a longitudinal central axis of the door and said fourth part being applied on one of said base parts. The dome not only further rigidifies the door but also protects the third part of the hinge.

Preferably said handle is hingedly mounted into said elongated cavity in such a manner as to move outwards of said elongated cavity. The handle offers a possibility to easily move the container. Due to the fact that the handle is lodged inside the elongated cavity, it will not form an obstacle when it is not in use.

Preferably said container is provided with a rack mounted into said container The rack offers a possibility to form compartments inside the container.

Preferably said container is mounted on wheels, at least two of said wheels being mounted on said one base part and at least two other of said wheels being mounted on said another base part. This enables an easy handling of the container.

The invention will now be described in more details with reference to the drawings illustrating a preferred embodiment of a container according to the invention. In the drawings:

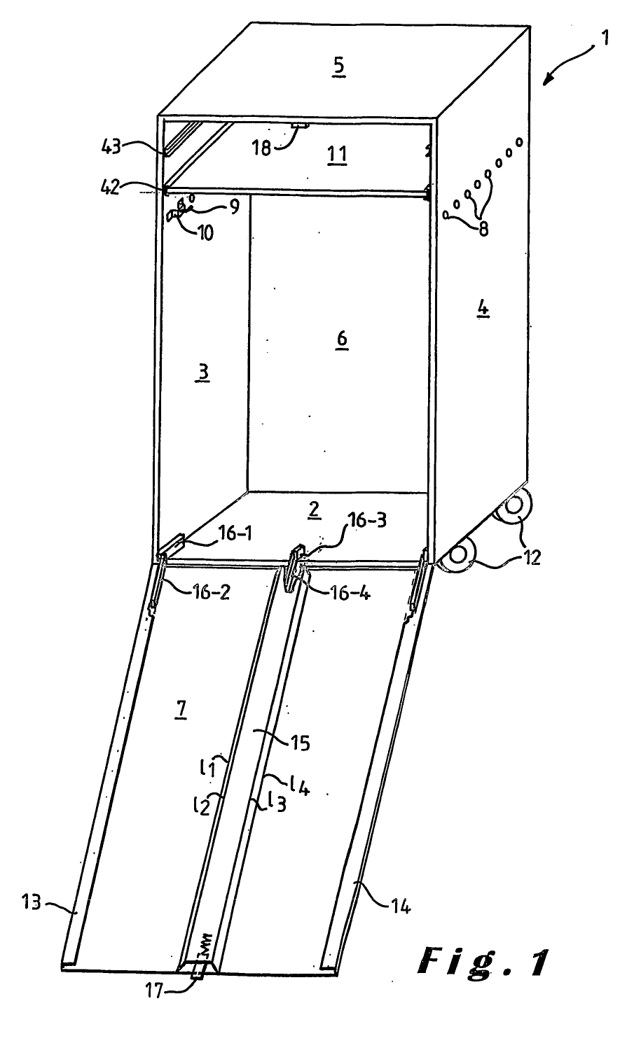

FIG. 1 shows an overall view of the container with the elements shifted into each other and with an open door;

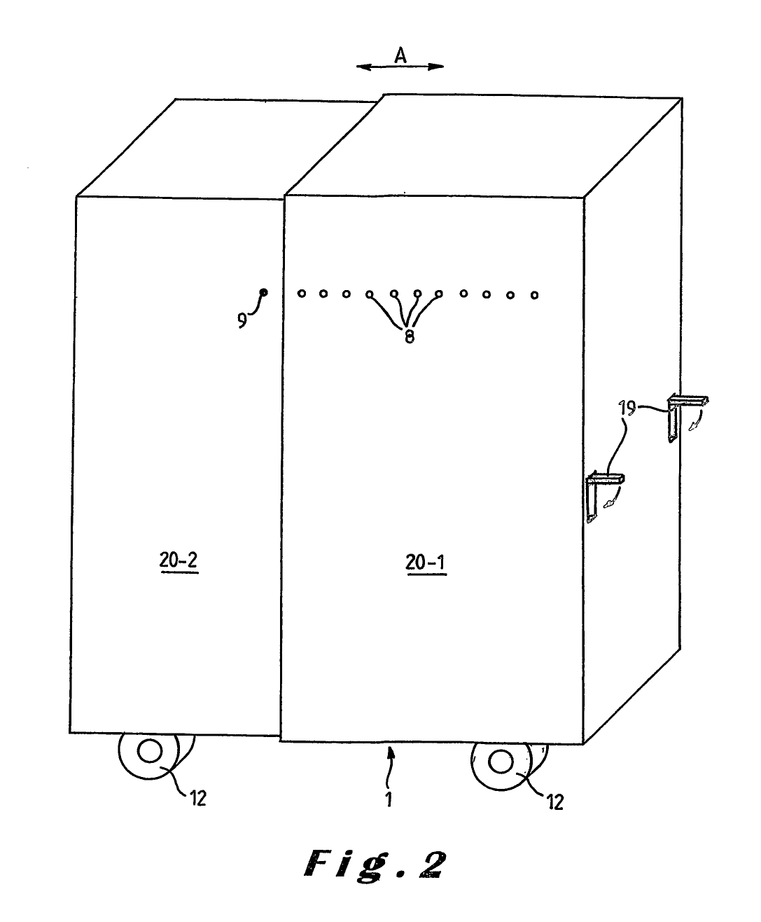

FIG. 2 shows an overall view of the container with the elements shifted out of each other and with closed doors;

FIG. 3 illustrates the fingers and grooves set-up of the base parts;

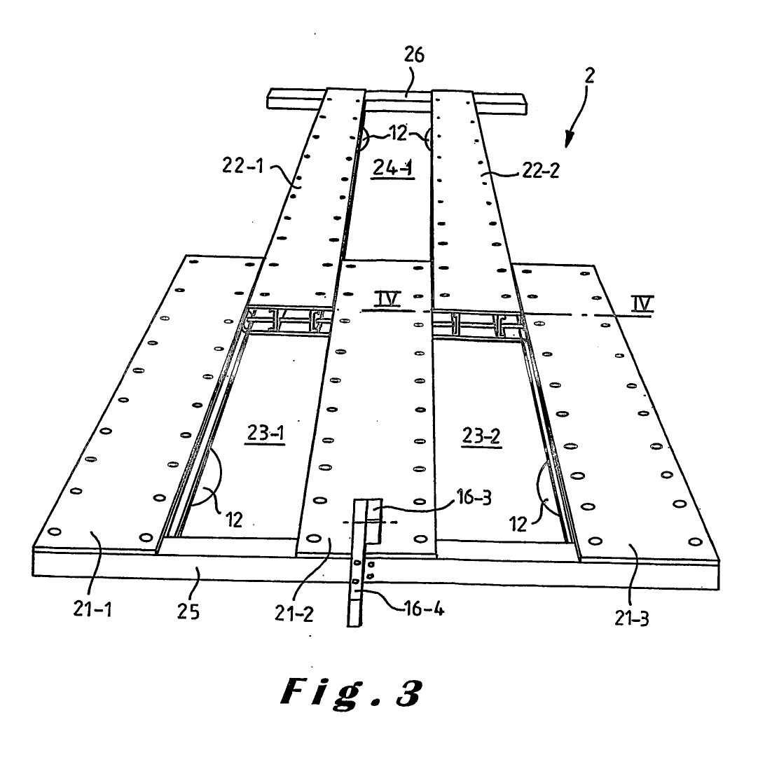

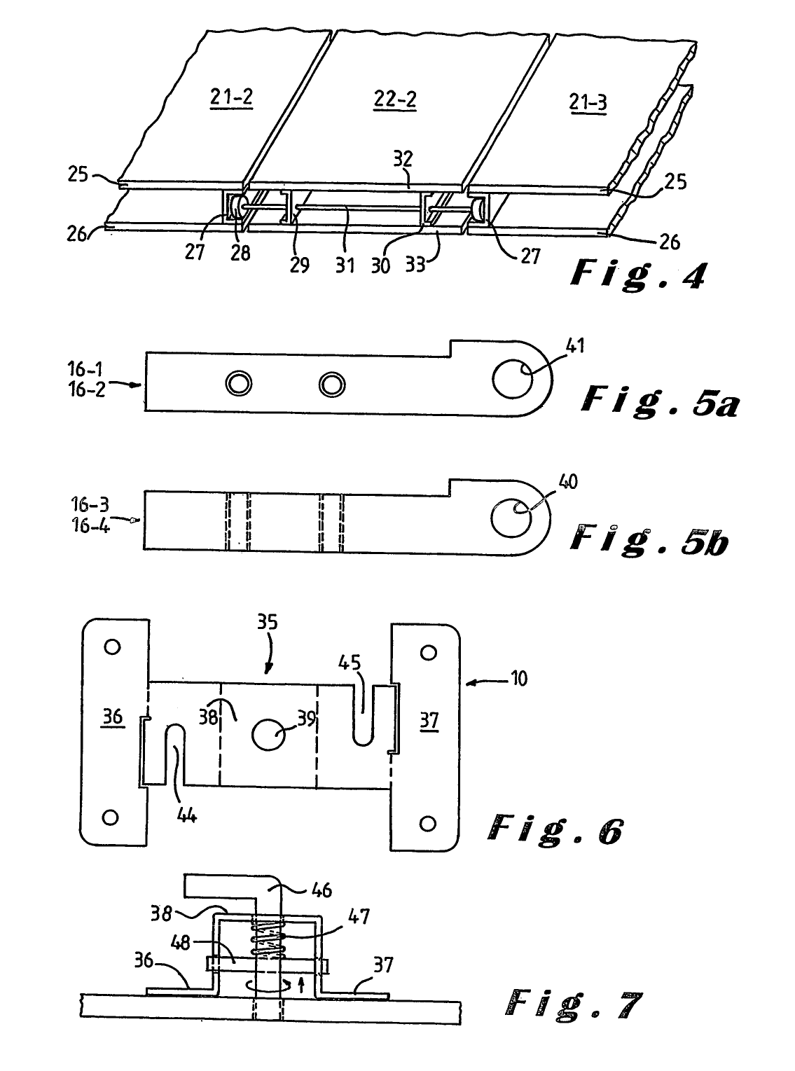

FIG. 4 illustrates a cross section along the line III-III′;

FIG. 5 shows the first and second hinge parts; and

FIGS. 6 and 7 illustrate the locking means.

In the drawings a same reference sign has been allotted to a same our analogous element.

The container illustrated in FIG. 1 is in particular provided for transporting goods. Once the goods are stored in the container, the latter is loaded on a truck or a cargo ship. More particularly the container according to the present invention is provided for transporting big and fragile goods such as photocopiers and electric apparatuses for medical purposes. Those big and fragile goods are generally transported in parts, whereby each part is carefully packed in a cardboard box. Once the goods are at their destination the intervention of one or more technicians is needed to assemble the different parts at the consignee's address. The container according to the invention enables to transport those big and fragile goods in an assembled state, thereby avoiding a relocation of one or more technicians. As will be described hereunder, the container according to the present invention is provided with different features for enabling such a transport.

As illustrated in FIGS. 1 and 2, the container 1 according to the invention is formed by at least two elements 20-1 and 20-2 which telescopically engage into each other thereby enabling to adapt the container's width. The total number of elements is preferably two as this facilitates the construction. Nevertheless a container with more than two elements could also be constructed.

Each element 20-1 and 20-2 comprises a base part formed by a set-up of fingers 21 and 22 and grooves 23 and 24 as illustrated in FIG. 3. The fingers and grooves are mounted in such a manner that the fingers of one base part engage into the grooves of another base part. thereby enabling a telescopic engagement of the base parts in order to adapt the container's width. In the embodiment illustrated in FIG. 3, the finger 21-2 of the one base part engages into the groove 24-1 of the other base part, whereas the fingers 22-1 and 22-2 of the other base part engage into the grooves 23-1 and 23-2 of the one base part. The number of fingers and grooves of each base part will be determined by the number of elements forming the container and by the dimension of the container. The base parts are also provided with wheels 12 for enabling an easy displacement of the container. The wheels furthermore are equipped with brakes or stopping members in order to block them when the container is at rest or during the telescopic engagement.

Each element further comprises a cover plate 2 extending, as illustrated in FIG. 1, within the volume delimited by the side walls 3 and 4 and by the front 7 and back wall 6. A top wall 5 is also provided in order to obtain a closed container. The front and/or back wall 7 and 6 are preferably formed by a door such as to enable an access to the inner volume of the container. The side walls 3 and 4 and the top wall are preferably made of aluminum and obtained by folding an aluminum sheet. Preferably the side wall 3 respectively 4 and a part of the top wall 5 are each time made of a single sheet. Both are then connected together upon forming the container, for example by linking both with a further piece of metal. The latter embodiment offers the advantage that for manufacturing, metal sheets of a smaller dimension, can be used which are more easy to handle.

As already mentioned, the front and/or the back wall are preferably formed by doors 7 and 6. The front and back wall extend substantially perpendicular to the direction in which the telescopic engagement (arrow A) extends, so as to enable an extension of the container in the direction in which the goods are loaded into the container. Each door 6, 7 is fixed to the container by means of hinges 16 so as to enable the door to pivot between a closed and an open position. In the closed position the door is locked by means of a locking member 17 and 18. The latter preferably comprises a protrusion 18 mounted on the top wall and a lock bolt 17 mounted on a spring in such a manner that in the closed position the lock bolt 17 is retained by the protrusion 18.

The door is also preferably made from a sheet of metal, in particular aluminum. The door is provided with side edges obtained by folding the metal sheet twice over an angle of substantially 90° in order to form at both lateral edges an elongated cavity 13 and 14. By this folding the structure of the door is rigidified and smooth edges are obtained. In order to further rigidify the door a dome 15 is applied in the door, substantially along a central longitudinal axis of the door. The dome 15 is obtained by folding the door along axis I1, I2, I3 and I4 substantially parallel with a central longitudinal axis of the door. By rigidifying the structure of the door the latter serves as a ramp for loading the goods into the container. The door is further mounted in such a manner that in at least one open position the under edge of the door substantially contacts the cover plate 2 of the element to which the door is attached. In such a manner, there is a smooth transition between the door and the inner volume of the container as there is no obstacle at the transition between the door and the cover plate. By having the door mounted in such a manner that its under edge and the cover plate contact each other at a same level, there is a continuous transition between the door and the cover plate.

The hinged connection between the door and the container's body further enables to stop the door opening movement at several positions. So for example the door can be completely opened and form a ramp between the ground level and the inner volume or the door could be kept open in an inclined position forming a bridge between the inner volume and an upper step of a staircase. This is of particular interest when a few stairs have to be mounted to enter a building.

The hinges situated at the side walls 3 and 4 have a first 16-1 and a second 16-2 part which are illustrated in more details in FIG. 5a. The first part 16-1 is fixed to the side wall, for example by means of screws and the second part 16-2 is lodged each time in the elongated cavity 13 and 14. In such a manner the hinge parts do not form an obstacle for entering the goods into the container. The first and second hinge part have both a perforation 41 through which extends an axle enabling both parts to pivot with respect to each other. The hinge further comprises a third 16-3 and a fourth 16-4 part mounted respectively in the base part and the dome 15. The third and fourth part are of an analogous construction as the first and second part. As illustrated in FIG. 5, the hinge parts are preferably formed by little bars.

The door is further provided with at least one handle 19 which is preferably hingedly mounted into the elongated cavity 13-14 as illustrated in FIG. 2. The hinged mounting of the handle enables to move the latter outwards the elongated cavity when the container needs to be displaced and store the handle into the cavity so that the handle does not form an obstacle when a plurality of containers are juxtaposed. According to a preferred embodiment, the handle is further provided with gripping means for example formed by a rubber coating or a series of rubber rings applied in longitudinal direction of the handle.

The container further comprises one or more racks 11 which are preferably slidably mounted in an upper part of the container. Guiding means 42 and 43 are provided to fix the rack and enable a sliding engagement of the rack. If only one rack is provided, the presence of the different guiding means enable to place the rack at several positions inside the container. The rack enables to store further goods in the container or to form a retaining member for applying a cushion, preferably an inflatable air cushion, which enables to block the goods into the container.

FIGS. 2, 3 and 4 illustrate the construction of the base parts of the container elements according to the present Invention. In the illustrated example, the container comprises two elements 20-1 and 20-2. Element 20-1 has a base part comprising the fingers 22-1 and 22-2 and the groove 24-1 whereas element 20-2 has a base part comprising the fingers 21-1, 21-2 and 21-3 and the grooves 23-1 and 23-2. The fingers 21 are linked together by means of coupling beam 25 whereas coupling beam 26 connects the fingers 22. The coupling beams are applied substantially perpendicular to the direction A in which the telescopic engagement extends. The fingers are preferably made of metal, in particular aluminum.

As illustrated in FIG. 4, the fingers 21 are formed by two plate segments 25 and 26 extending substantially parallel with respect to each other. The plates 25 and 26 are connected together by means of intermediate elements 27 formed by a C-shaped profile. The intermediate elements have a predetermined dimension and keep the plates 25 and 26 at a predetermined distance from each other. The C-shaped profile forming the intermediate elements are applied at the edge of the finger 21 in such a manner that they face the groove 23 of the element to which they belong. So the intermediate element forms as if to say a C-shaped guiding member along the edge facing the groove.

The fingers 22 are also formed by two plates 32 and 33 extending substantially parallel with respect to each other. The plates 32 and 33 are connected together by means of intermediate elements 29. The latter being provided to carry an axle 31 to which wheels 28 are connected. The intermediate elements 29 are for example formed by blocks or C-shaped profiles. The wheels are applied in such a manner that they house into the C-shaped profile of the intermediate elements 27.

Instead of using plates it could of course also be possible to use extruded profiles. It Is however important that the wheels are guided by the C-shaped profiles as this determines the guiding during the telescopic engagement.

Upon engagement of the elements into each other, the fingers 21 slide over the wheels 28. As the latter can not leave the C-shaped profile, the engagement of the fingers 21 into groove 24 is guided thereby preventing that the fingers 21 and 22 disengage from each other. The whole engaging movement is thus guided by the C-shaped profile and the wheels which are both in the base parts.

Each base part is further provided with a cover plate 2 extending within the inner volume of the container. One of the cover plates, for example the one fixed to element 20-1 forms the top cover plate when the container is in the engaged configuration. The other cover plates being mounted in such a manner that they shift underneath the top cover plate during the telescopic engagement. Therefor the cover plates are made of thin metal sheets, preferably aluminum. Each cover plate is each time fixed to its dedicated base part, for example at the coupling beam. Since the cover plates shift underneath the top cover plate during the telescopic movement, they will extend over the whole floor of the container thereby providing a continuous floor for the goods.

In order to lock the elements in a plurality of positions each corresponding to a stage within the telescopic engagement, locking means 10 are provided as illustrated in the FIGS. 1, 6 and 7. The locking means are applied against the side wall of the elements, whereas one element is provided with a series of perforations 8 and the other with a lock 35. The lock comprises two flanges 36 and 37 fixed to the side wall and an U-shaped part 38 extending between the flanges 36 and 37. The U-shaped part is provided with a central hole 39 aligned with the perforations 8 and with two slots 44 and 45 applied on opposite walls of the U-shaped part and extending in opposite direction. A pen 46 extends through the hole 39 and is provided with a handle. A spring 47 is applied around the pen and extends between the front wall of the U-shaped part and a further pen 48.

In order to lock the elements the pen 46 is rotated and shifted so as to enter one of the holes 8. The spring then pushes the further pen 48 against the side wall. For unlocking the elements the pen 46 is rotated and pulled against the resilient action of the spring 47. The pen 46 is locked by rotating the latter so that the further pen 48 is blocked in the slots 44 and 45 thereby retaining the pen 46.

Preferably a small bag is applied to one of the side walls in order to insert the shipping documents therein. The bag is for example formed by a cut-out in this wall.

1. A container, in particular a container provided for transporting goods, said container being formed by at least two elements each comprising a base part and side walls, said base parts being formed by a set-up of fingers and grooves mounted in such a manner that the fingers of one base part engage into the grooves of another base part, thereby enabling a telescopic engagement of the base parts in order to adapt the container's width, characterised in that the fingers of one of the base parts have at their edges, facing their respective groove, each time an essentially C-shaped profile in which is housed a wheel, said wheel being mounted on an axle fixed on a finger of another base part, and wherein each base part is provided with a cover plate extending within a volume delimited by said side walls, one of said cover plates forming a top cover plate and the other cover plates being mounted in such a manner that they shift underneath said top cover plate during said telescopic engagement.

2. A container as claimed in claim 1, characterised in that said container further comprises a front and a back wall extending substantially perpendicular to a direction in which said telescopic engagement extends, one of said front or back walls being provided with a door fixed to said container by means of hinges, said door being applied in such a manner as to pivot towards at least one open position where an under edge of said door substantially contacts one of said cover plates and forms a ramp towards said volume of said container.

3. A container as claimed in claim 1, characterised in that said container is provided with locking means provided to lock said elements in a plurality of positions each corresponding to a stage within said telescopic engagement.

4. A container as claimed in claim 1, characterised in that said fingers of each base element are each connected to a coupling beam applied substantially perpendicular to a direction in which said telescopic engagement extends.

5. A container as claimed in claim 1, characterised in that said fingers are formed by two plate segments extending substantially parallel with respect to each other and connected together by means of intermediate elements in such a manner that the two plate segments are at a predetermined distance from each other, and wherein the intermediate elements applied in said one base part form said C-shaped profile and the intermediate elements of said another base part are provided to carry said axle.

6. A container as claimed in claim 2, characterised in that said door is formed by a metal sheet, in particular aluminum, and provided with side edges obtained by folding said metal sheet twice over an angle of substantially 90° in order to form an elongated cavity, said hinges having a first hinge part lodged into said elongated cavity.

7. A container as claimed in claim 6, characterised in that said hinges have a second hinge part, said first and second hinge parts being each time formed by a little bar and connected together by an axle so as to enable a hinge movement, said second hinge part being applied against said side wall.

8. A container as claimed in claim 7, characterised in that said hinges have a third and a fourth part, said third part being applied under a dome obtained by folding said metal sheet along an axis substantially parallel with a central longitudinal axis of the door and said fourth part being applied on one of said base parts.

9. A container as claimed in claim 6, characterised in that said door is provided with a locking member.

10. A container as claimed in claim 6, characterised in that said door is provided with at least one handle.

11. A container as claimed in claim 10, characterised in that said handle is hingedly mounted into said elongated cavity in such a manner as to move outwards of said elongated cavity.

12. A container as claimed in claim 1, characterised in that said container is provided with a rack mounted into said container.

13. A container as claimed in claim 12, characterised in that said rack is removably mounted into at least two different positions.

14. A container as claimed in claim 12, characterised in that said container is provided with at least one inflatable cushion applied inside said container.

15. A container as claimed in claim 1, characterised in that said container is mounted on wheels, at least two of said wheels being mounted on said one base part and at least two other of said wheels being mounted on said another base part.
